(19) United States
(12) Patent Application Publication
(10) Pub. No.: US 2006/0232227 A1
(43) Pub. Date: Oct. 19, 2006

(54) Membrane touch dimmer

(76) Inventors: Michael Ostrovsky, Brooklyn, NY (US); Yun Wu, Bayside, NY (US); Jenkin P. Hua, Plainsboro, NJ (US); Alfred J. Lombardi, Syosset, NY (US); William J. Ross, West Hartford, CT (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/363,888

(22) Filed: Feb. 27, 2006

Related U.S. Application Data
(60) Provisional application No. 60/657,906, filed on Mar. 2, 2005.

(51) Int. Cl. H05B 37/02

(52) U.S. Cl. 315/291

(57) ABSTRACT

There is disclosed a two wire touch operated dimmer controlled by a membrane potentiometer. Adjusting the DC potential on the membrane potentiometer changes the output potential to a load. In many prior art touch operated dimmers controlled by membrane potentiometers, there is no isolation between the line power and the DC voltage on the membrane potentiometer. Thus, if the membrane is damaged, a user will be exposed to a ground current and possible shock when the membrane is touched. This invention avoids the above noted unsafe condition by employing a high frequency generator and a ground fault current limiting circuit which includes resistors.

This application claims priority pursuant to 35 U.S.C. 119(e) from Provisional Patent Application No. 60/657,906, filed Mar. 2, 2005.

### BACKGROUND OF THE INVENTION

1. Field of the Disclosure

The present invention relates generally to dimmers for controlling the voltage from a source to a load and, more specifically, to dimmers controlled by a membrane potentiometer and having a ground fault current limiting circuit.

2. Description of the Related Art

Dimmers are normally located between a source of power such as 120 VAC and a load such as a lamp, to control the brightness of the lamp by providing a variable output voltage to the lamp. The output voltage of a standard dimmer can be controlled by moving a mechanical device such as a slide or a rotary component attached to a potentiometer. A touch dimmer uses a membrane potentiometer to vary the output voltage. The difference between a standard dimmer and a touch dimmer is that the touch dimmer does not need a mechanically moving part.

A touch dimmer can includes a touch- or pressure-operated device such as a membrane potentiometer which is activated by touching a flexible membrane to control a light dimming circuit. The output voltage of the dimmer is normally determined by the place on the membrane potentiometer where it is touched. Thus, the brightness of a lamp can be controlled by where the membrane is touched.

FIG. 1 is a block diagram 100 of a prior art touch operated dimmer control circuit. The touch operated dimmer has a membrane potentiometer mounted behind a flexible film. A control circuit coupled to the membrane potentiometer is provided to control a dimming circuit in response to momentary voltage signals from the membrane potentiometer. The control circuit can include an electronically adjustable voltage divider which provides a continuous voltage, and a comparator which adjusts the electronically adjustable voltage divider to provide a continuous voltage Vc which corresponds to a momentary voltage Vm from membrane potentiometer 104. The momentary voltage, Vₘ, which corresponds to a desired output voltage level, V_{C}, is obtained by applying pressure to a selectable point on the membrane potentiometer 104. A voltage sensor 106 detects this voltage and turns on clock 108. Clock 108 provides clock pulses which are fed to a wiper movement control pin of electronically adjustable voltage divider which incrementally moves wiper 110 along resistive element 112 to provide voltage, V_{C}, which is fed to comparator 114 and to dimming circuit 102. Comparator 114 compares the momentary voltage Vₘ with the output voltage level V_{C} to feed a comparator output voltage 116 to an up/down input of electronically adjustable voltage divider 120. The up/down input determines the direction in which the wiper 110 moves when enabling clock pulses are received at the wiper movement input. As an example, when Vₘ is greater than V_{C}, the comparator output 116 is high and the wiper 110 moves to increase V_{C} with each enabling clock pulse. Similarly, when Vₘ is less than V_{C}, the comparator output 116 is low and the wiper 110 moves to decrease V_{C} with each enabling clock pulse. Thus, V_{C} is driven to approach Vₘ. When pressure on membrane potentiometer 104 is released, voltage is removed from voltage sensor 106, which turns clock 108 off. When clock 108 is turned off, it stops providing enabling pulses to the wiper movement control input of the electronically adjustable voltage divider and wiper 110 does not move. The voltage V_{C}, which is provided to the dimming circuit 102, determines the power provided to the load.

In use it is possible that the membrane of the membrane potentiometer may be damaged. Due to cost and size issues, dimmers using membrane potentiometers no not normally have isolation between the source of power and the DC voltage. Therefore, if the membrane is damaged, a ground current can be present which can present a shock hazard to a person who touches the membrane. What is needed is a dimmer having a membrane potentiometer that can provide protection against the above noted unsafe condition.

### SUMMARY OF THE DISCLOSURE

There is disclosed a two wire touch operated dimmer controlled by a membrane potentiometer. Adjusting the DC potential on the membrane potentiometer changes the output potential to a load. In many prior art touch operated dimmers controlled by membrane potentiometers, there is no isolation between the line power and the DC voltage on the membrane potentiometer. Thus, if the membrane is damaged, a user will be exposed to a ground current and possible shock when the membrane is touched. This invention avoids the above noted unsafe condition by employing a high frequency generator and a ground fault current limiting circuit which includes resistors.

The foregoing has outlined, rather broadly, a preferred blending feature, for example, of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a prior art touch operated dimmer control circuit including a membrane potentiometer;

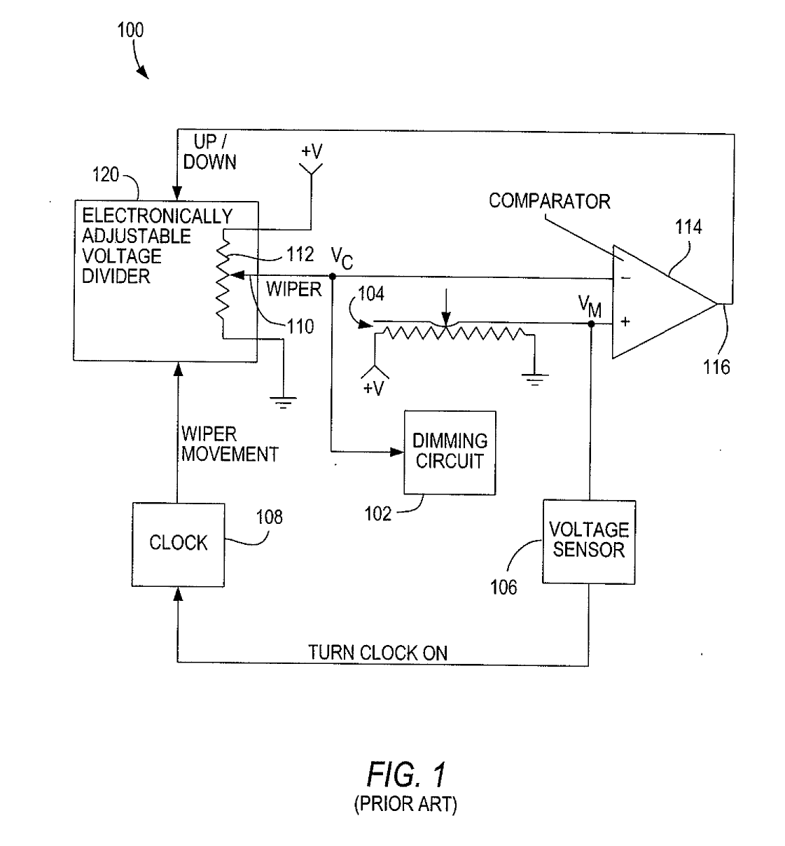

FIG. 2 is a block diagram of a touch operated dimmer control circuit with a ground fault current limiting circuit in accordance with the principles of the invention;

FIG. 3 is a schematic diagram of a series resonant capacitor ground fault current limiting circuit;

FIG. 4 is a schematic diagram of a series resonant inductive ground fault current limiting circuit;

FIGS. 5A-5B are schematic diagrams of other embodiments of inductive ground fault current limiting circuits;

FIGS. 6A-6B are schematic diagrams of a resistor ground fault current limiting circuit; and

FIG. 7 is a front perspective view of a wall plate with a touch operated dimmer.

### DETAILED DESCRIPTION

Techniques and methods are disclosed for a touch dimmer including a ground fault current limiting circuit controlled by a membrane potentiometer. A high-frequency generator can be coupled to a ground fault current limiting circuit to reduce the risk of shock injury to personnel due to a damaged membrane. The disclosure also discloses a control system for controlling the output voltage level of the dimmer.

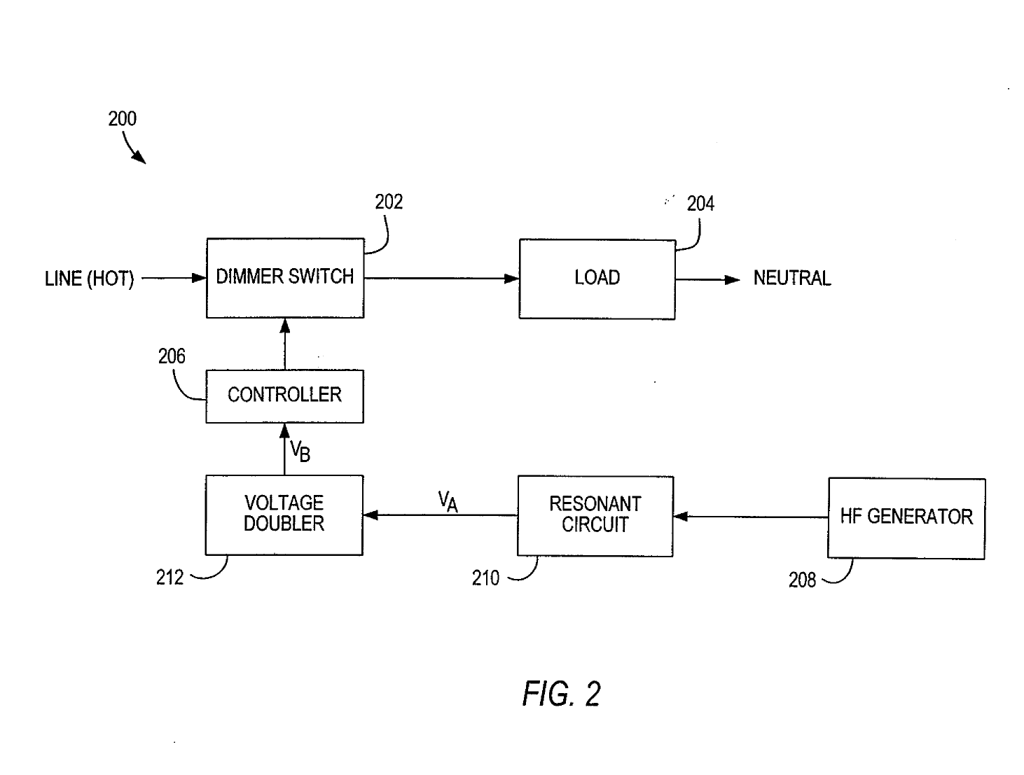

Referring to FIG. 2, there is shown a block diagram of a touch operated dimmer control circuit with a ground fault current limiting circuit 200. The circuit 200 includes a dimmer switch 202 coupled to the phase conductor of a source of potential such as 120VAC. The output of dimmer switch 202 is coupled through a load 204 such as a lamp to the neutral conductor of the source of potential. The value of the output voltage of the dimmer switch is controlled by a controller 206. A resonant circuit 210, coupled to receive the output signal of a high frequency generator 208, is coupled in series with a voltage doubler 212 to form a ground fault current limiting circuit. The output of voltage doubler 212 is connected to an input of the controller 206. The resonant circuit 210 is tuned to the same frequency as the high frequency generator 208 and the output of voltage doubler 212, V_{B}, controls the output of the controller 206 which, in turn, controls the output signal of dimmer switch 202.

The voltage at the output of dimmer switch 202 is controlled by the high frequency generator 208 and resonant circuit 210. As discussed below, resonant circuit 210 includes a membrane potentiometer which varies the voltage from the high frequency generator 208 to produce an output voltage VA. Voltage VA is determined by the place where the membrane of the membrane potentiometer is touched by a user.

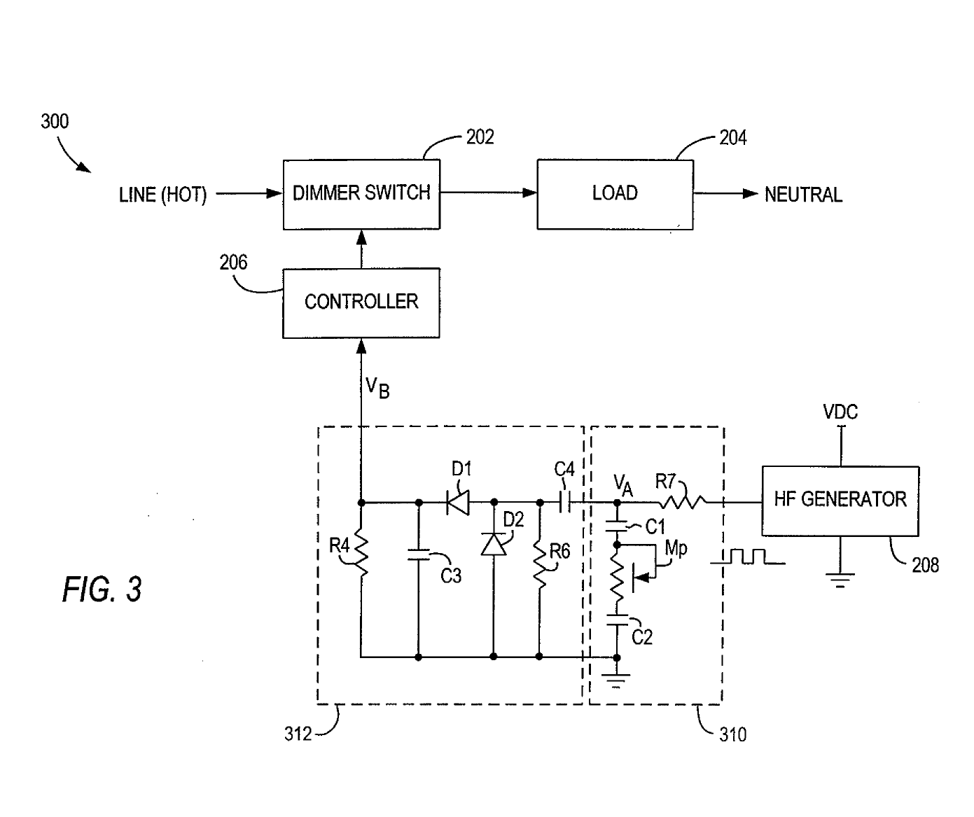

FIG. 3 shows a schematic diagram of a touch operated dimmer ground fault current limiting circuit 300 having a capacitor resonant circuit 310 coupled in series with a voltage doubler circuit 312. The membrane potentiometer is coupled in series with and located between capacitors C1, C2. Capacitors C1 and C2 and the resistor element of the membrane potentiometer provides a path for high frequency signals from the high frequency generator. Capacitors C3, C4 in combination with diodes D1, D4 comprise the voltage doubler 312. The dimmer switch 202, load 204 and controller 206 have been previously described in discussing FIG. 2 and, therefore, in the interest of brevity, will not be repeated here.

When the membrane potentiometer in the series resident circuit 310 is touched, voltage level V_{A} will change to a voltage which is related to the point at which the membrane potentiometer is touched. The voltage V_{A} is rectified to DC voltage, V_{B}, by the voltage doubler circuit 312 and is fed to controller 206. Controller 206 generates a corresponding control signal which sets the output voltage from the dimmer switch 202 to the load 204.

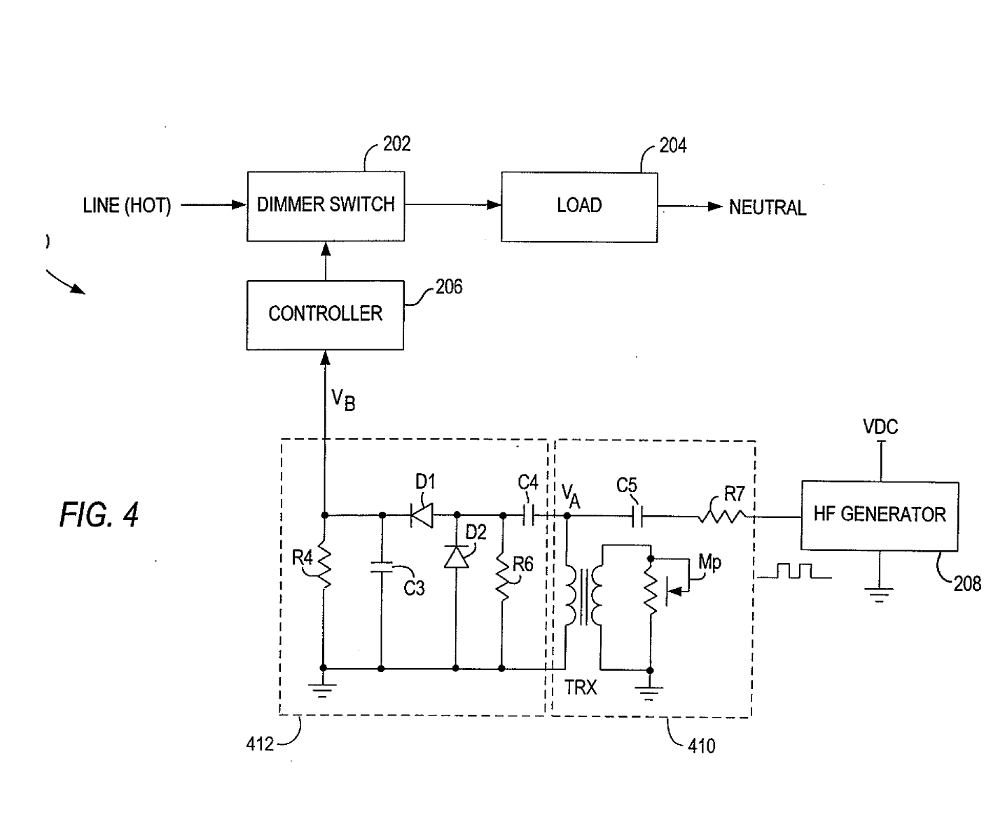

FIG. 4 is a schematic diagram of a touch operated dimmer ground fault current limiting circuit 400 having a series inductive resonant circuit 410 coupled in series with a voltage doubler circuit 412. The series inductive resonant circuit 410 includes a capacitor CS connected in series with the primary inductance, normally the primary winding, of transformer TRX, and membrane potentiometer is connected across the secondary of transformer TRX. The resonant frequency of the circuit is set to be the same as the frequency generated by high frequency generator 208. The dimmer switch 202, load 204 and controller 206 have been previously described in discussing FIG. 2 and, therefore, in the interest of brevity, will not be repeated here.

When the membrane potentiometer which is connected in series with the secondary of the transformer TRX is touched, the load in the secondary winding of the transformer is reflected into the primary winding and causes the voltage VA a t the output of the resonant circuit 410 to change to a voltage which is related to the place where the membrane is touched. The voltage VA is rectified to a DC voltage V_{B} by the voltage doubler circuit 412 and is fed to controller 206. Controller 206 generates a corresponding control signal which sets the output voltage from the dimmer switch 202 to the load 204.

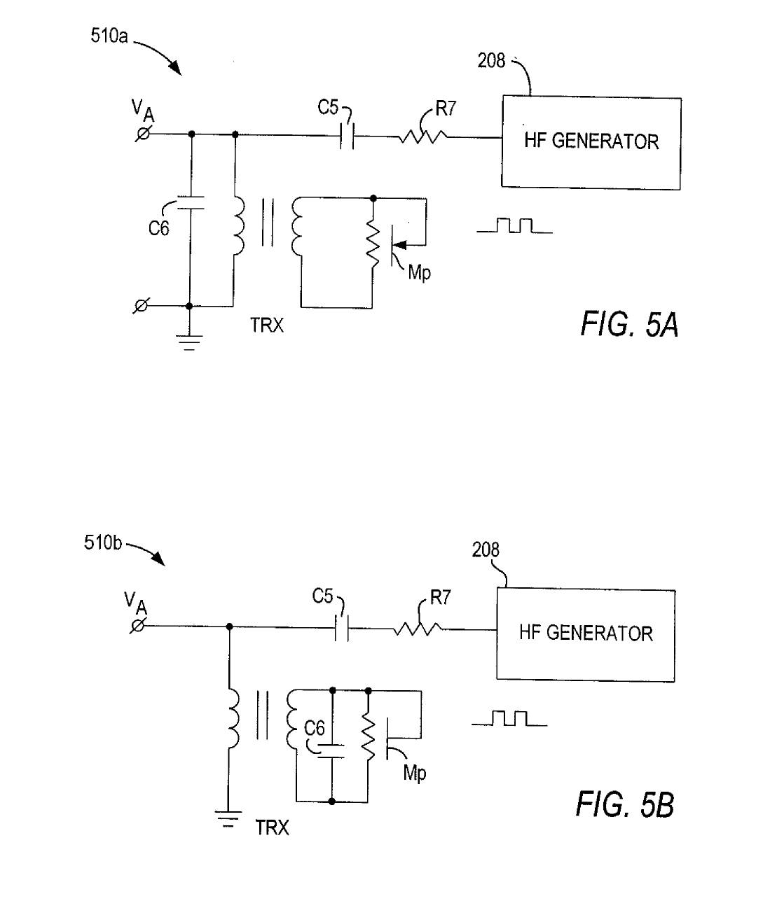

FIGS. 5A-5B are schematic diagrams of further embodiments of inductive ground fault current limiting circuits having resonant circuit 510a or 510b, each of which includes an inductive parallel resonant circuit. Referring to FIG. 5A, there is shown a circuit having an inductive parallel resonant circuit 510a having capacitor C6 connected in parallel with the primary winding of transformer TRX. Capacitor C6 and inductance of the primary winding of transformer TRX comprises a parallel resonance circuit having a resonant frequency which is the same as the frequency generated by high frequency generator 208. A membrane potentiometer is connected in the secondary winding of transformer TRX. Touching the membrane of the membrane potentiometer affects the load in the secondary of transformer TRX which is reflected into the primary winding of transformer TRX and causes a voltage VA to be generated which relates to the place where the membrane is touched. As noted above, the voltage, V_{A}, at the output of the resonant circuit 510a is fed to voltage doubler, the output of which is fed to a controller as described above. Referring to FIG. 5B, the circuit shown is similar to that of FIG. 5A except that capacitor C6 in FIG. 5B is connected across the secondary winding of transformer TRX. In all other respects, the various connections of the circuit of FIG. 5B is substantially the same as that of FIG. 5A.

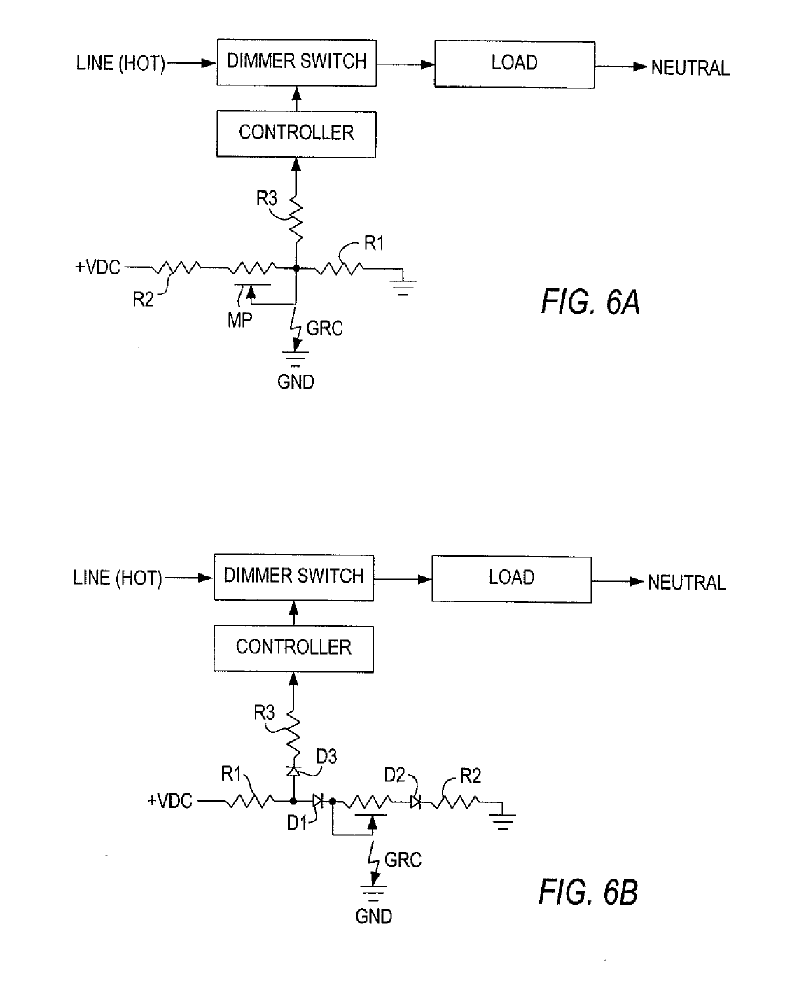

FIGS. 6A-6B are schematic diagrams of a resistor ground leakage current limiting circuit. Referring to FIG. 6A, resistors R1, R2 and R3 are ground current limit resistors. The values of resistors R1 and R2 are selected to limit the ground current to less than 500 uA. Selecting a membrane potentiometer having a very high resistance will allow a user to sense a full range of DC voltage on the membrane potentiometer. However, a high resistance membrane potentiometer may have greater noise sensitivity than a lower resistance membrane potentiometer. FIG. 6B shows an alternative embodiment of a resistor ground leakage current limit circuit. In this embodiment, resistors R1, R2, R3 and rectifiers D1, D2 D3 comprise the limit circuit. When the membrane potentiometer conducts to ground, a half cycle of the line voltage is fed to the membrane potentiometer. Therefore, a lower resistance for resistors R1, R2 and R3 can be selected as compared to the resistors of circuit of FIG. 6A. Hence, a lower value of resistance for the membrane potentiometer can also be selected which has the advantage of reduced noise sensitivity.

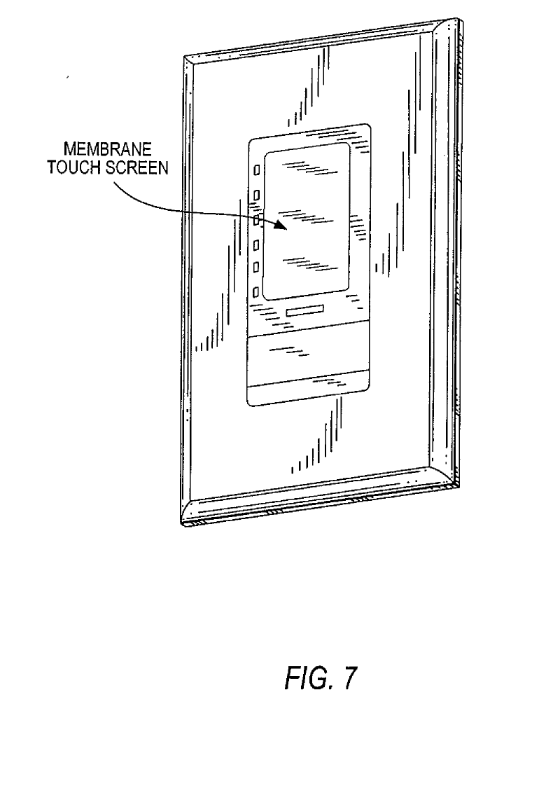

FIG. 7 is a front perspective view of a wall plate 700 with a touch operated dimmer 702 having a membrane potentiometer. The wall plate 700 is designed to be positioned over a standard wall box and has an opening for receiving the membrane potentiometer.

While there have been shown and described and pointed out the fundamental novel features of the invention as applied to the preferred embodiments, as is presently contemplated for carrying them out, it will be understood that various omissions and substitutions and changes in the form and details of the devices described and illustrated and in their operation may be made by those skilled in the art without departing from the spirit of the invention.

What is claimed is:

1. A touch operated dimmer for controlling the voltage to a load comprising:
a high frequency generator;
a resonant circuit including the potentiometer of a membrane potentiometer wherein the resonant circuit is tuned to the same frequency as the high frequency generator when a ground leakage current above a defined level is not present on the membrane potentiometer and wherein the voltage passed by said resonant circuit from said membrane potentiometer is determined by the position on the membrane of the membrane potentiometer touched by a user and the frequency to which the resonant circuit is tuned.

2. The touch operated dimmer for controlling the voltage to a load of claim 1 further comprising:
a voltage doubler coupled to receive the signal passed by said resonant circuit.

3. The touch operated dimmer for controlling the voltage to a load of claim 2 further comprising:
a first capacitor coupled to one end of the potentiometer of said membrane potentiometer; and
a second capacitor is coupled to the other end of the potentiometer.

4. The touch operated dimmer for controlling the voltage to a load of claim 3 wherein the frequency to which the resonant circuit is tuned is changed when the ground leakage current is above the defined level.

5. The touch operated dimmer for controlling the voltage to a load of claim 4 wherein the dimmer is a two-wire dimmer.

6. The touch operated dimmer for controlling the voltage to a load of claim 4 wherein the resonant circuit comprises a first capacitor coupled to one end of said potentiometer and a second capacitor coupled to the other end of said potentiometer.

7. The touch operated dimmer for controlling the voltage to a load of claim 4 wherein the resonant circuit comprises a transformer having a primary winding and a secondary winding.

8. The touch operated dimmer for controlling the voltage to a load of claim 7 wherein the secondary winding of said transformer is coupled across the potentiometer of said membrane potentiometer.

9. The touch operated dimmer for controlling the voltage to a load of claim 8 further comprising:
a capacitor coupled in series with said primary winding of said transformer.

10. The touch operated dimmer for controlling the voltage to a load of claim 10 wherein the dimmer is a two-wire dimmer.

11. The touch operated dimmer for controlling the voltage to a load of claim 7 wherein the secondary winding of said transformer is coupled across the potentiometer of said membrane potentiometer and the primary winding of said transformer is coupled across a capacitor.

12. The touch operated dimmer for controlling the voltage to a load of claim 7 wherein the secondary winding of said transformer is coupled in parallel with the potentiometer of said membrane potentiometer and a capacitor.

13. A touch operated dimmer for controlling the voltage to a load comprising a membrane potentiometer having a potentiometer;
one end of said potentiometer is coupled to a first resistor;
the other end of said potentiometer is coupled to a second resistor;
the junction of said first resistor and said potentiometer is coupled to a controller through a third resistor
wherein said first and second resistors limit the ground leakage current on the membrane potentiometer.

14. The touch operated dimmer for controlling the voltage to a load of claim 13 wherein the resistance of the potentiometer is greater than the resistance of said first and second resistors.

15. A touch operated dimmer for controlling the voltage to a load comprising a membrane potentiometer having a potentiometer;
one end of said potentiometer is adapted to be coupled to a source of DC potential through a first diode in series with a first resistor;
the other end of said potentiometer is coupled through a second diode in series with a second resistor to a ground;
the junction of said first diode and said first resistor is coupled to a controller through a third diode in series with a third resistor
wherein said first and second resistors limit the ground leakage current on the membrane potentiometer.
